(19) United States
(12) Patent Application Publication
(10) Pub. No.: US 2024/0365302 A1
(43) Pub. Date: Oct. 31, 2024

(54) Distributed-Tone Resource Unit Allocation And Scheduling For Mixed-Distribution Bandwidth Operations In Wireless Communications

(71) Applicant: MediaTek Inc., Hsinchu City (TW)

(72) Inventors: Shengquan Hu, San Jose, CA (US); Jianhan Liu, San Jose, CA (US); Thomas Edward Pare, JR., San Jose, CA (US)

(21) Appl. No.: 18/645,360

(22) Filed: Apr. 24, 2024

Related U.S. Application Data
(60) Provisional application No. 63/498,032, filed on Apr. 25, 2023.

(51) Int. Cl. H04W 72/0453; H04L 5/00

(52) U.S. Cl. CPC H04W 72/0453; H04L 5/0094

(57) ABSTRACT

Techniques pertaining to distributed-tone resource unit (DRU) allocation and scheduling for mixed-distribution bandwidth operations in wireless communications are described. An apparatus (e.g., access point (AP)) allocates a plurality of DRU sizes on a plurality of distribution bandwidths to a plurality of stations (STAs). The apparatus then communicates with one or more of the plurality of STAs with a plurality of DRUs that are scheduled with one or more of the plurality of DRU sizes on one or more of the plurality of distribution bandwidths such that there is no overlap of tones of the plurality of DRUs.

### CROSS REFERENCE TO RELATED PATENT APPLICATION(S)

The present disclosure is part of a non-provisional patent application claiming the priority benefit of U.S. Provisional Patent Application No. 63/498,032, filed 25 Apr. 2023, the content of which herein being incorporated by reference in its entirety.

### TECHNICAL FIELD

The present disclosure is generally related to wireless communications and, more particularly, to distributed-tone resource unit (DRU or dRU) allocation and scheduling for mixed-distribution bandwidth operations in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) in accordance with the Institute of Electrical and Electronics Engineers (IEEE) 802.11 standards, different stations (STAs) may have different bandwidth-support capabilities. For example, some STAs may only support up to 80 MHz bandwidth while other STAs may support a wider bandwidth such as 160 MHz or more. It is thus a challenge to allocate resources and schedule transmissions in a network environment with STAs having different bandwidth-support capabilities. Therefore, there is a need for a solution of dRU allocation and scheduling for mixed-distribution bandwidth operations in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to DRU allocation and scheduling for mixed-distribution bandwidth operations in wireless communications. Under various proposed schemes in accordance with the present disclosure, mixed-distribution bandwidth operations may be enabled with DRU resource assignment and scheduling described herein. It is believed that implementations of one or more of the proposed schemes may address or otherwise alleviate the aforementioned issue(s).

In one aspect, a method may involve a processor of an apparatus allocating a plurality of dRU sizes on a plurality of distribution bandwidths to a plurality of STAs. The method may also involve the processor communicating with one or more of the plurality of STAs with a plurality of DRUs that are scheduled with one or more of the plurality of DRU sizes on one or more of the plurality of distribution bandwidths such that there is no overlap of tones of the plurality of DRUs.

In another aspect, an apparatus may include a transceiver configured to communicate wirelessly and a processor coupled to the transceiver. The processor may allocate a plurality of DRU sizes on a plurality of distribution bandwidths to a plurality of STAs. The processor may communicate, via the transceiver, with one or more of the plurality of STAs with a plurality of DRUs that are scheduled with one or more of the plurality of DRU sizes on one or more of the plurality of distribution bandwidths such that there is no overlap of tones of the plurality of DRUs.

It is noteworthy that, although description provided herein may be in the context of certain radio access technologies, networks and network topologies such as, Wi-Fi/WLAN, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example scenario under a proposed scheme in accordance with the present disclosure.

FIG. 7 is a diagram of an example simulation under a proposed scheme in accordance with the present disclosure.

FIG. 8 is a diagram of an example design under a proposed scheme in accordance with the present disclosure.

FIG. 9 is a diagram of an example simulation under a proposed scheme in accordance with the present disclosure.

FIG. 10 is a diagram of an example design under a proposed scheme in accordance with the present disclosure.

FIG. 11 is a block diagram of an example communication system in accordance with an implementation of the present disclosure.

FIG. 12 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to DRU allocation and scheduling for mixed-distribution bandwidth operations in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular (non-distributed) RU (RRU) refers to a RU with tones that are continuous (e.g., adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, a 26-tone distributed-tone RU may be interchangeably denoted as DRU26 (or iRU26, or dRU26), a 52-tone distributed-tone RU may be interchangeably denoted as DRU52 (or iRU52, or dRU52), a 106-tone distributed-tone RU may be interchangeably denoted as DRU106 (or iRU106, or dRU106), a 242-tone distributed-tone RU may be interchangeably denoted as DRU242 (or iRU242, or dRU242), and so on. Moreover, an aggregate (26+52)-tone regular multi-RU (MRU) may be interchangeably denoted as MRU78 (or rMRU78, or RMRU78), an aggregate (26+106)-tone regular MRU may be interchangeably denoted as MRU132 (or rMRU132, or RMRU132), and so on. Furthermore, an aggregate (26+52)-tone distributed-tone MRU (DMRU or dMRU) may be interchangeably denoted as DMRU132 (or dMRU132), and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

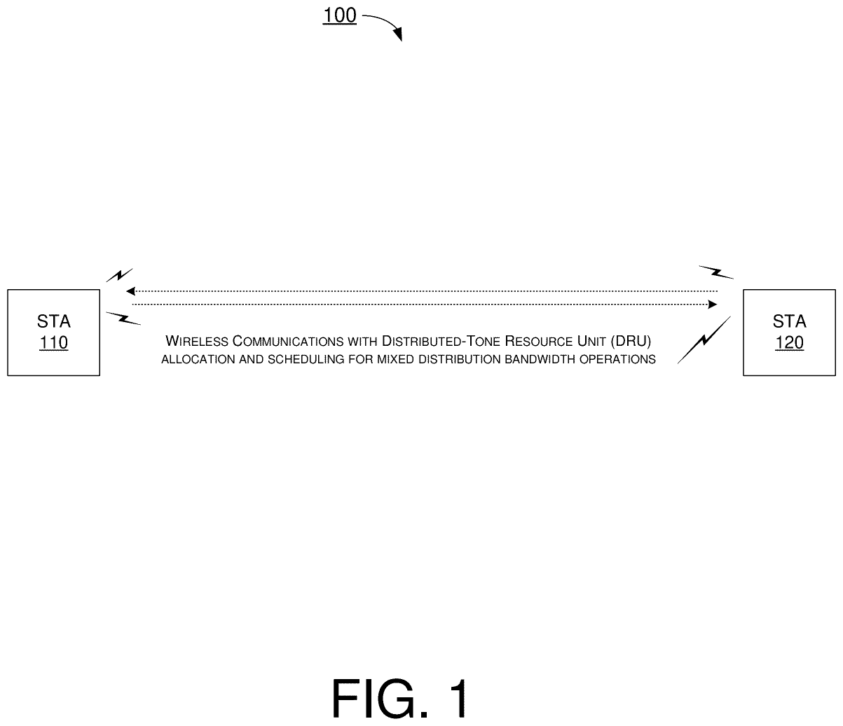

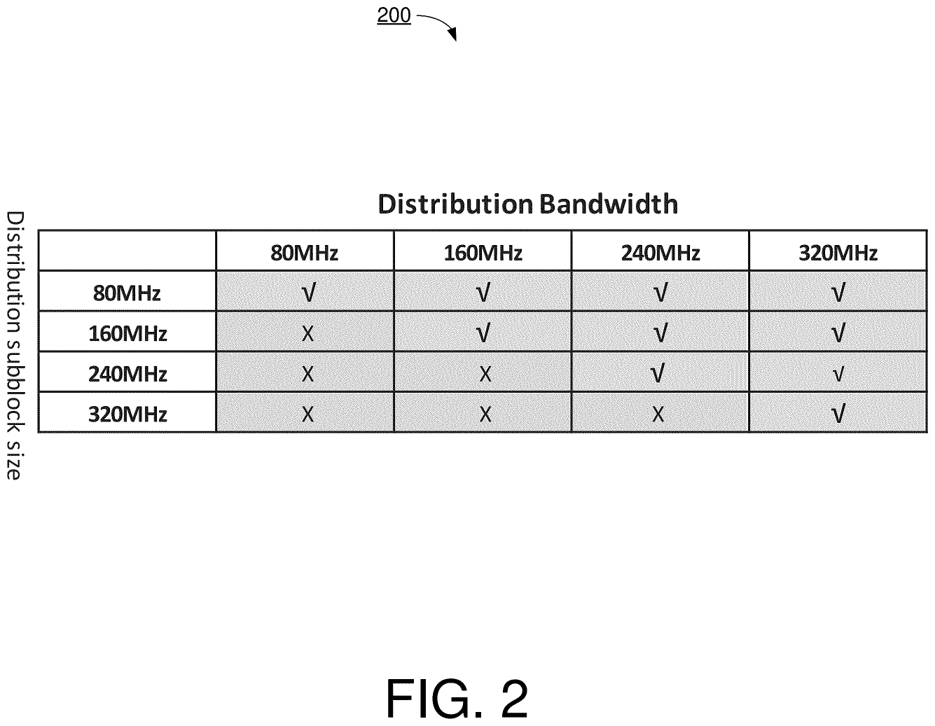

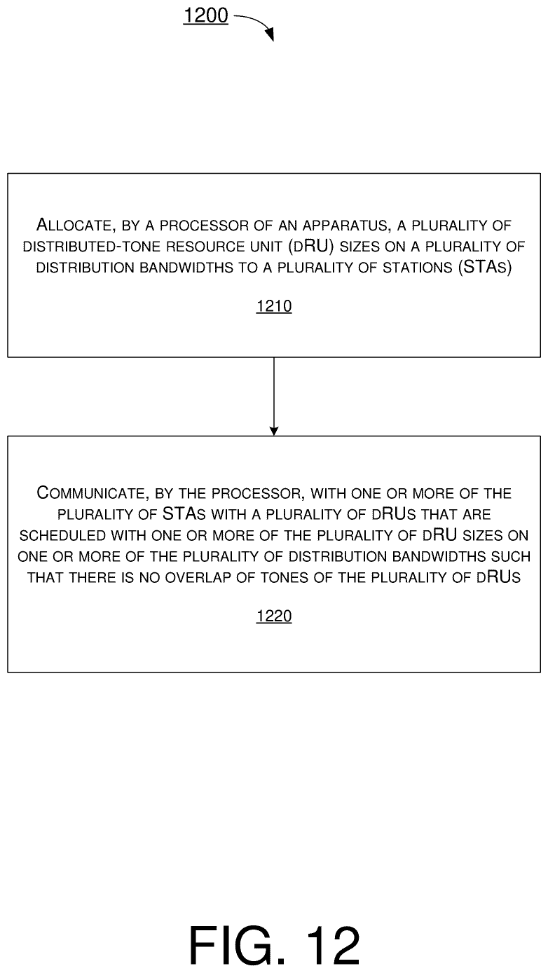

FIG. 1 illustrates an example network environment 100 in which various solutions and schemes in accordance with the present disclosure may be implemented. FIG. 2˜FIG. 12 illustrate examples of implementation of various proposed schemes in network environment 100 in accordance with the present disclosure. The following description of various proposed schemes is provided with reference to FIG. 1˜FIG. 12.

Referring to FIG. 1, network environment 100 may involve at least a STA 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the various proposed schemes of DRU allocation and scheduling for mixed-distribution bandwidth operations in wireless communications in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example design 200 under a proposed scheme in accordance with the present disclosure. Referring to FIG. 2, the table summarizes the availability of different DRU distribution block sizes on different distribution bandwidths such as, for example, 80 MHz, 160 MHz, 240 MHz and 320 MHz. Under the proposed scheme, a distribution block size of a given size may be distributed over a bandwidth of an equal or greater size. For instance, a distribution block size of 80 MHz may be distributed over a distribution bandwidth of 80 MHz, 160 MHz, 240 MHz or 320 MHz. Additionally, a distribution block size of 160 MHz may be distributed over a distribution bandwidth of 160 MHz, 240 MHz or 320 MHz. Moreover, a distribution block size of 240 MHz may be distributed over a distribution bandwidth of 240 MHz or 320 MHz. Furthermore, a distribution block size of 320 MHz may be distributed over a distribution bandwidth of 320 MHz.

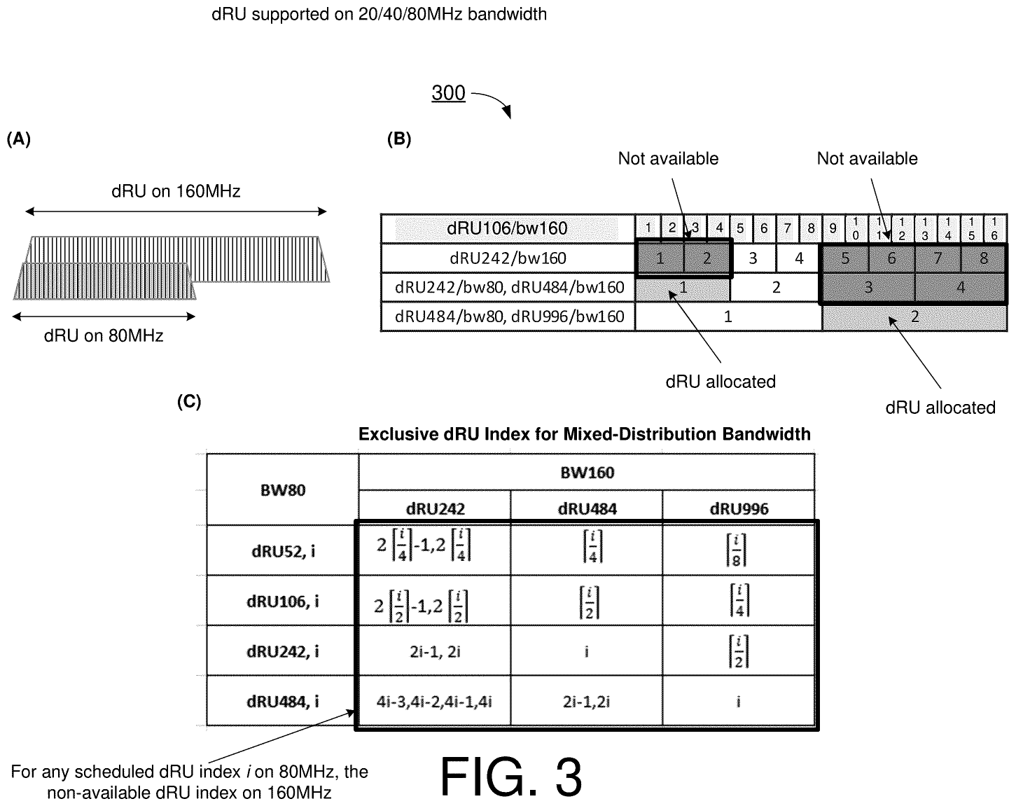

FIG. 3 illustrates an example design 300 under a proposed scheme in accordance with the present disclosure. Design 300 may pertain to a mixed distribution of DRUs on bandwidths 80 MHz and 160 MHz. Under the proposed scheme, DRU scheduling and allocation in a mixed distribution bandwidth operation with 80 MHz and 160 MHz bandwidths may follow a hierarchical structure similar to the hierarchical structure used for distribution of RRUs. Part (A) of FIG. 3 shows an example of a mixed-distribution of DRUs on bandwidths 80 MHz and 160 MHz.

Part (B) of FIG. 3 shows an example of different DRU distributions on different bandwidths and corresponding indexes under the proposed scheme. For instance, a 106-tone DRU (DRU106) distributed on 160 MHz may be associated with an index number among 1˜16. Similarly, a 242-tone DRU (DRU242 or dRU242) distributed on 160 MHz may be associated with an index number among 1 ˜ 8. Moreover, a DRU242 distributed on 80 MHz may be associated with an index number among 1˜4, and a 484-tone DRU (DRU484 or dRU484) distributed on 160 MHz may be associated with an index number among 1˜4. Furthermore, a DRU484 distributed on 80 MHz may be associated with an index number between 1 and 2, and a 996-tone DRU (DRU996 or dRU996) distributed on 160 MHz may be associated with an index number between 1 and 2.

Under the proposed scheme, mixed-distribution of DRUs may be mutually exclusive so as to avoid tone overlap in the frequency domain between the tones/subcarriers of the DRUs. In one example shown in part (B) of FIG. 3, when a DRU242 with index 1 is distributed on 80 MHz (or when a DRU484 with index 1 is distributed on 160 MHz), there cannot also be a DRU242 distributed on 160 MHz with index 1 or 2. In another example shown in part (B) of FIG. 3, when a DRU484 with index 2 is distributed on 80 MHz (or when a DRU996 with index 2 is distributed on 160 MHz), there cannot also be a DRU242 distributed on 160 MHz with index 5 or 6 or 7 or 8. In the same example, there cannot also be a DRU242 distributed on 80 MHz with index 3 or 4. Neither can there also be a DRU484 distributed on 160 MHz with index 3 or 4. Part (C) of FIG. 3 shows a table that summarizes mutual exclusion of mixed-distribution of different DRUs on 80 MHz and 160 MHz under the proposed scheme. Referring to the table, in a mixed-distribution of DRUs on bandwidths 80 MHz and 160 MHz, for any scheduled or otherwise allocated DRU with an index i on 80 MHz (e.g., DRU52_{,i}, DRU106_{,i}, DRU242_{,i}, or DRU484_{,i}), there cannot also be scheduling or allocation of a corresponding DRU on 160 MHz (e.g., DRU242, DRU484 or DRU996).

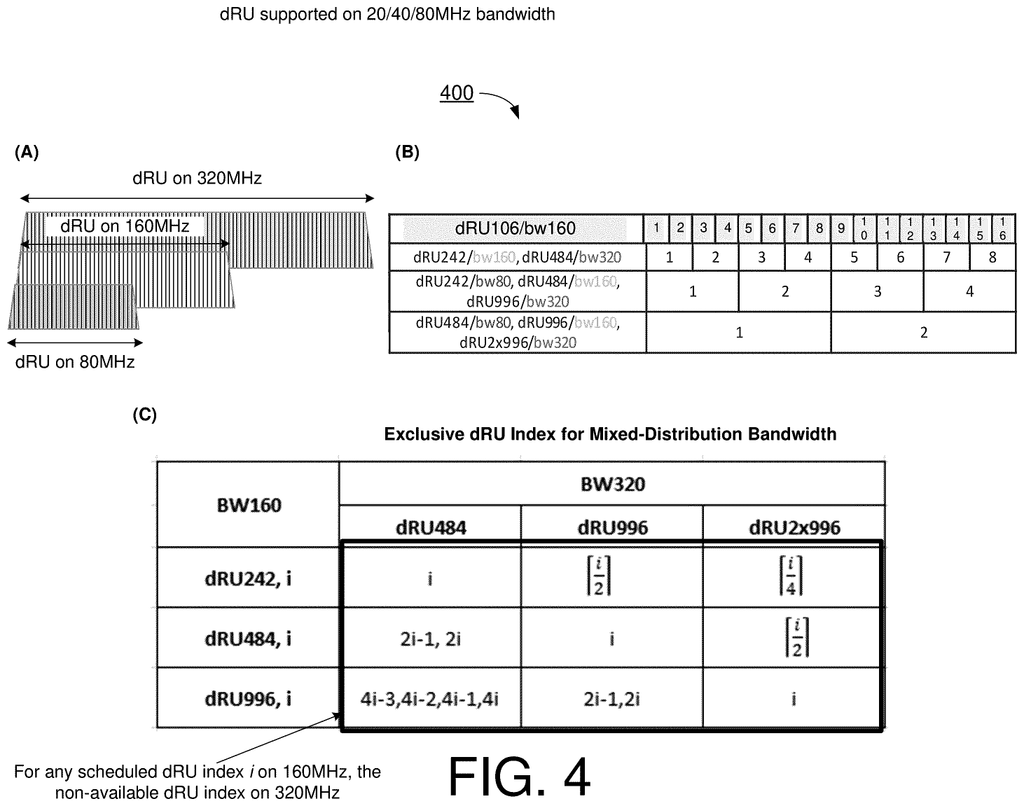

FIG. 4 illustrates an example design 400 under a proposed scheme in accordance with the present disclosure. Design 400 may pertain to a mixed distribution of DRUs on bandwidths 160 MHz and 320 MHz. Under the proposed scheme, DRU scheduling and allocation in a mixed distribution bandwidth operation with 160 MHz and 320 MHz bandwidths may follow a hierarchical structure similar to the hierarchical structure used for distribution of RRUs. Part (A) of FIG. 4 shows an example of a mixed-distribution of DRUs on bandwidths 80 MHz, 160 MHz and 320 MHz.

Part (B) of FIG. 4 shows an example of different DRU distributions on different bandwidths and corresponding indexes under the proposed scheme. For instance, a DRU106 distributed on 160 MHz may be associated with an index number among 1˜16. Similarly, a DRU242 distributed on 160 MHz and a DRU484 distributed on 320 MHz may each be associated with an index number among 1˜8. Moreover, a DRU242 distributed on 80 MHz, a DRU484 distributed on 160 MHz and a DRU996 distributed on 320 MHz may each be associated with an index number among 1˜4. Furthermore, a DRU484 distributed on 80 MHz, a DRU996 distributed on 160 MHz and a DRU(2×996) distributed on 320 MHz may each be associated with an index number between 1 and 2.

Under the proposed scheme, mixed-distribution of DRUs may be mutually exclusive so as to avoid tone overlap in the frequency domain between the tones/subcarriers of the DRUs. In one example shown in part (B) of FIG. 4, when a DRU242 with index 1 is distributed on 80 MHz (or when a DRU484 with index 1 is distributed on 160 MHz or when a DRU996 with index 1 is distributed on 320 MHz), there cannot also be a DRU242 distributed on 160 MHz with index 1 or 2 or a DRU484 distributed on 320 MHz with index 1 or 2. Part (C) of FIG. 4 shows a table that summarizes mutual exclusion of mixed-distribution of different DRUs on 160 MHz and 320 MHz under the proposed scheme. Referring to the table, in a mixed-distribution of DRUs on bandwidths 160 MHz and 160 MHz, for any scheduled or otherwise allocated DRU with an index i on 160 MHz (e.g., DRU242_{,i}, DRU484_{,i} or DRU996_{,i}), there cannot also be scheduling or allocation of a corresponding DRU on 320 MHz (e.g., DRU484, DRU996 or DRU(2×996)).

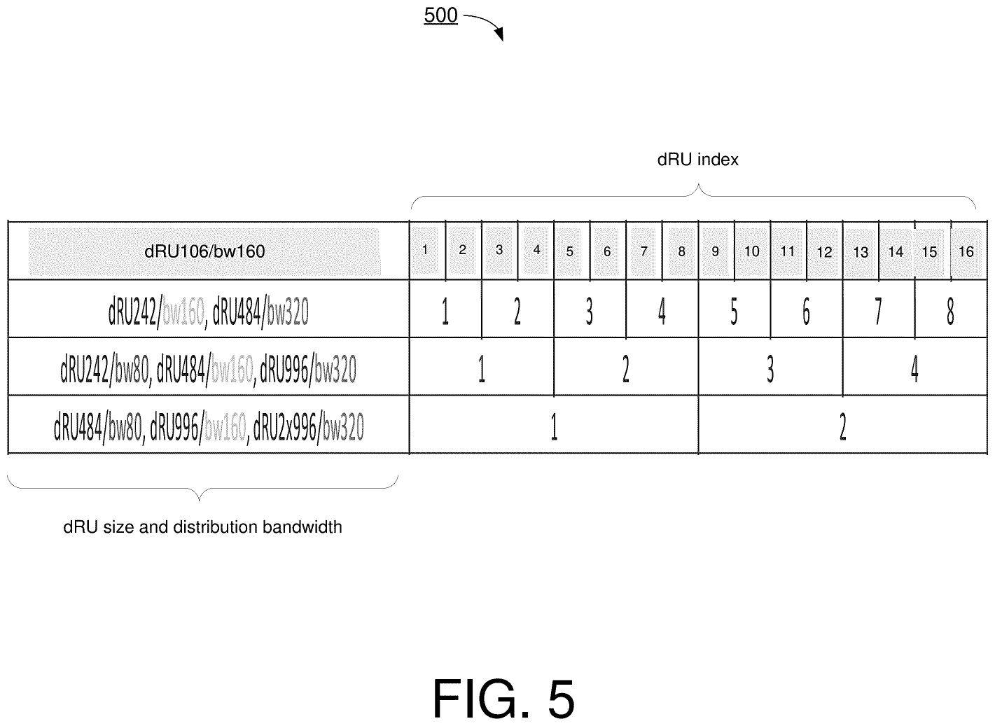

FIG. 5 illustrates an example design 500 under a proposed scheme in accordance with the present disclosure. Design 500 may pertain to a hierarchical scheduling structure for DRUs with a mixed distribution on bandwidths 80 MHz, 160 MHz and 320 MHz. Under the proposed scheme, DRU scheduling and allocation in a mixed distribution bandwidth operation with 80 MHz, 160 MHz and 320 MHz bandwidths may follow a hierarchical structure similar to the hierarchical structure used for distribution of RRUs. Referring to FIG. 5, for a given DRU size and associated distribution bandwidth, there may be a corresponding range of index numbers that may be assigned or otherwise associated with the scheduled/allocated DRU(s).

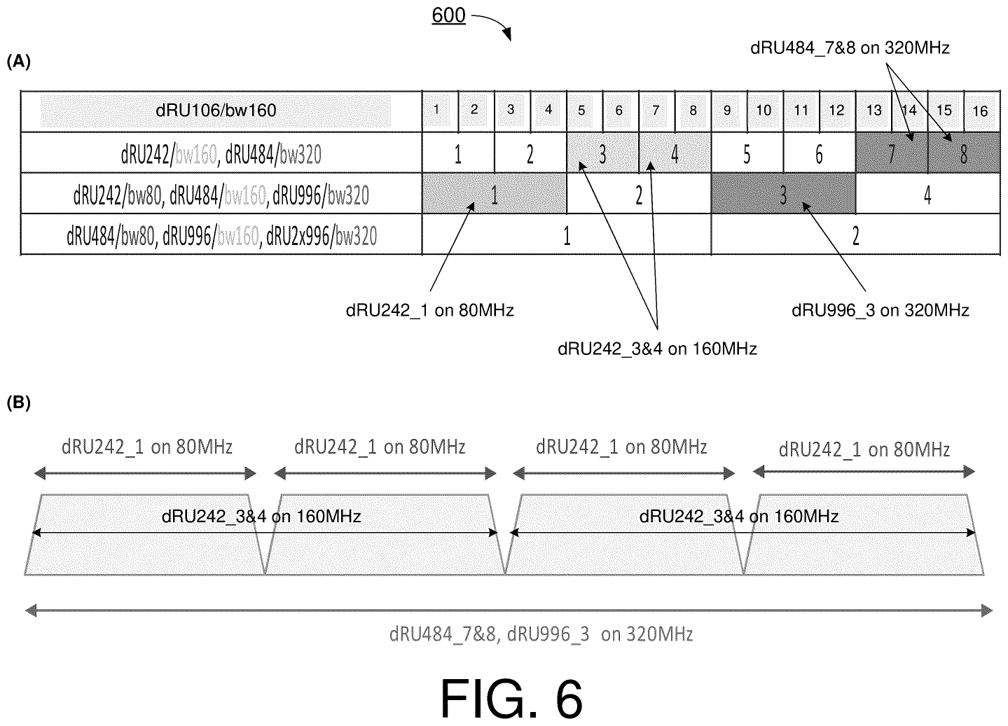

FIG. 6 illustrates an example scenario 600 under a proposed scheme in accordance with the present disclosure. Scenario 600 may pertain to examples based on design 500. Under the proposed scheme, mixed-distribution of DRUs may be mutually exclusive so as to avoid tone overlap in the frequency domain between the tones/subcarriers of the DRUs. Referring to part (A) of FIG. 6, an AP (e.g., STA 120) may schedule and allocate DRUs to different STAs (e.g., including STA 110) of different capabilities for transmission. For instance, a first STA may be scheduled and allocated a DRU with index 1 (e.g., a DRU242 on 80 MHz, a DRU484 on 160 MHz or a DRU996 on 320 MHz), a second STA may be scheduled and allocated two DRUs with indexes 3 and 4 (e.g., two DRU242's on 160 MHz or two DRU484's on 320 MHz), and a third STA may be scheduled and allocated one DRU with index 3 (e.g., a DRU242 on 80 MHz, a DRU484 on 160 MHz or a DRU996 on 320 MHz) and two DRUs with indexes 7 and 8 (e.g., two DRU242's on 160 MHz or two DRU484's on 320 MHz). Specifically, in the example shown in part (A) of FIG. 6, the first STA may be scheduled/allocated a DRU242_1 on 80 MHz, the second STA may be scheduled/allocated DRU242_3 and DRU242_4 on 160 MHZ, and the third STA may be scheduled/allocated a DRU996_3 on 320 MHz as well as DRU484_7 and DRU484_8 on 320 MHz. Accordingly, there is no overlap in the frequency domain between the tones (or subcarriers) of the different DRUs scheduled/allocated to the STAs. Part (B) of FIG. 6 shows an example of a mixed-distribution of DRUs on bandwidths 80 MHz, 160 MHz and 320 MHz from the example shown in part (A) of FIG. 6, such as DRU242_1 on 80 MHz, DRU242_3 and DRU242_4 on 160 MHz, as well as DRU484_7, DRU484_8 and DRU996_3 on 320 MHz.

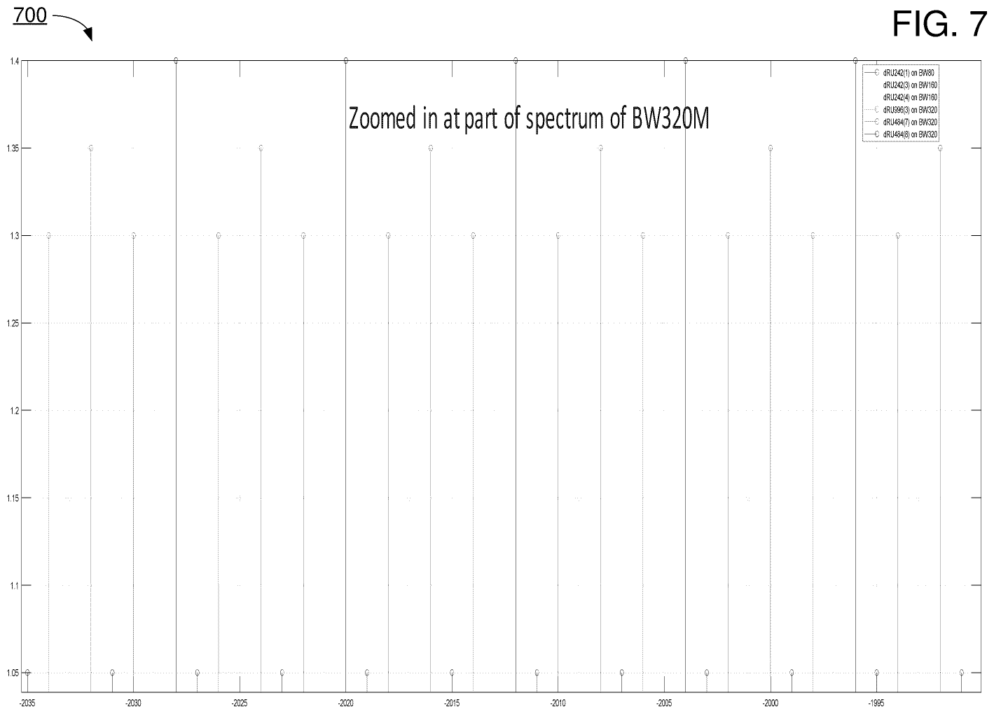

FIG. 7 illustrates an example simulation 700 under a proposed scheme in accordance with the present disclosure. Simulation 700 may pertain to a mixed-distribution of DRUs on bandwidths 80 MHz, 160 MHz and 320 MHz under the proposed scheme. Referring to FIG. 7, the entire 320 MHz may be filled with different DRUs with different distribution sizes/bandwidths without any tone overlap in the frequency domain.

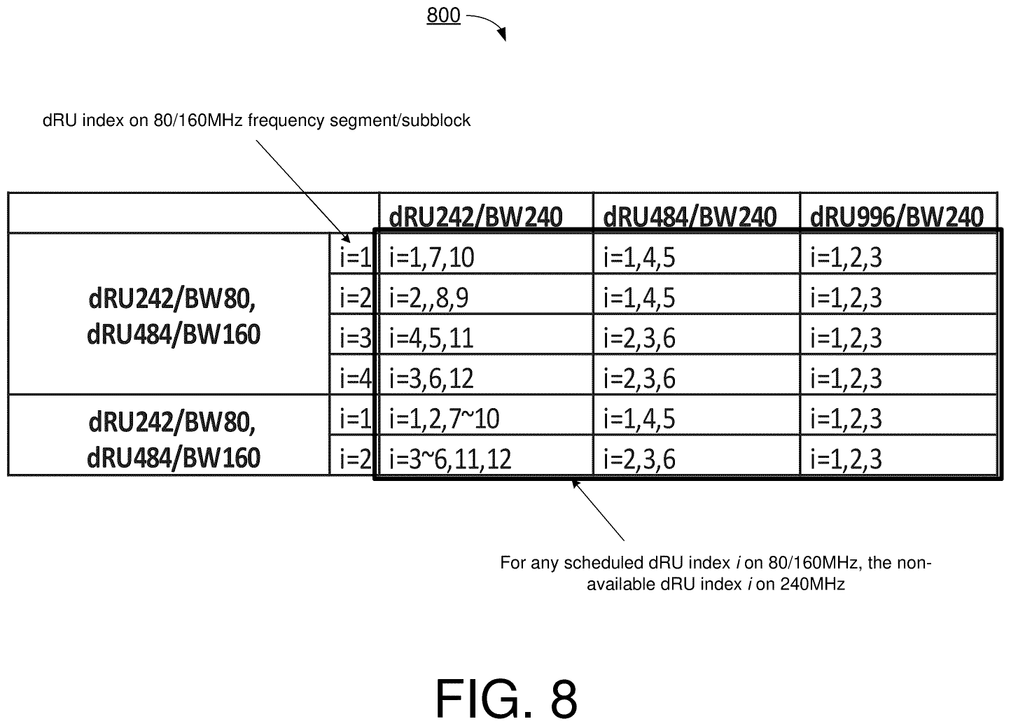

FIG. 8 illustrates an example design 800 under a proposed scheme in accordance with the present disclosure. Design 800 may pertain to a mixed-distribution of DRUs on bandwidths 80 MHz, 160 MHz and 240 MHz. FIG. 8 shows a table that summarizes mutual exclusion of mixed-distribution of different DRUs on 80 MHz (or 160 MHz) and 240 MHz under the proposed scheme. Referring to the table, in a mixed-distribution of DRUs on bandwidths 80 MHz (or 160 MHz) and 240 MHz, for any scheduled or otherwise allocated DRU with an index i on 80 MHz or 160 MHz (e.g., DRU242_{,i} on 80 MHz or DRU484, on 160 MHz), there cannot also be scheduling or allocation of a corresponding DRU on 240 MHz (e.g., DRU242_{,i} , DRU484_{,i} or DRU996_{,i}).

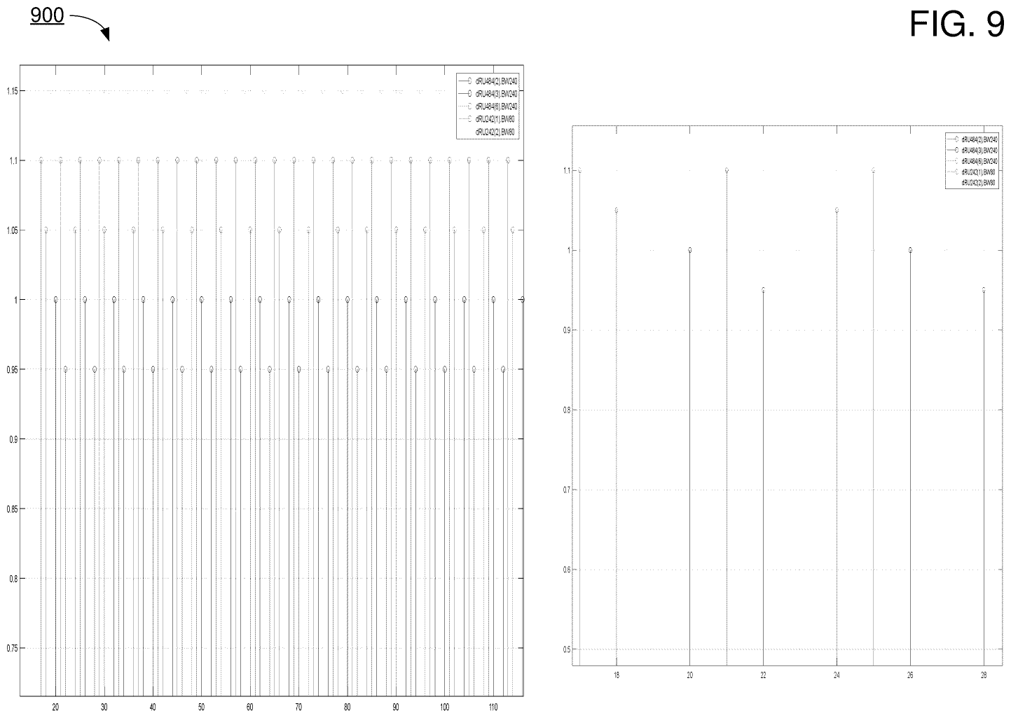

FIG. 9 illustrates an example simulation 900 under a proposed scheme in accordance with the present disclosure. Simulation 900 may pertain to a mixed-distribution of DRUs on bandwidths 80 MHa and 240 MHz under the proposed scheme. Referring to FIG. 9, the entire 240 MHz and 80 MHz may be filled with different DRUs with different distribution sizes/bandwidths without any tone overlap in the frequency domain.

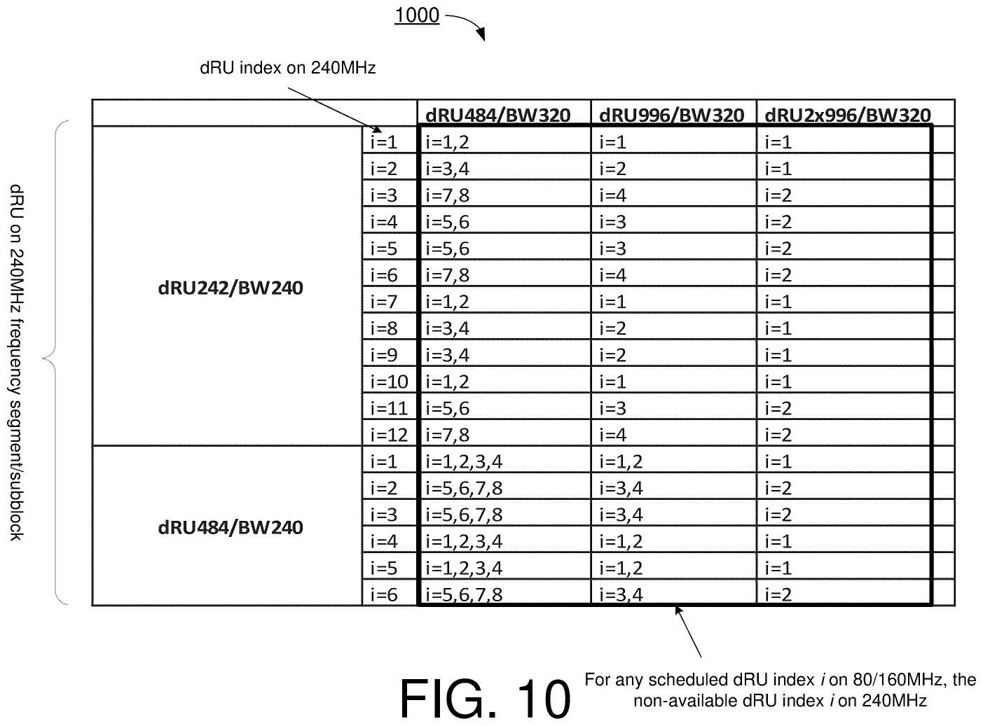

FIG. 10 illustrates an example design 1000 under a proposed scheme in accordance with the present disclosure. Design 1000 may pertain to a mixed-distribution of DRUs on bandwidths 240 MHz and 320 MHz. FIG. 10 shows a table that summarizes mutual exclusion of mixed-distribution of different DRUs on 240 MHz and 320 MHz under the proposed scheme. Referring to the table, in a mixed-distribution of DRUs on bandwidths 240 MHz and 320 MHz, for any scheduled or otherwise allocated DRU with an index i on 240 MHz (e.g., DRU242_{,i} or DRU484_{,i}), there cannot also be scheduling or allocation of a corresponding DRU on 320 MHz (e.g., DRU484_{,i}, DRU996_{,i} or DRU(2×996)_{,i}).

### Illustrative Implementations

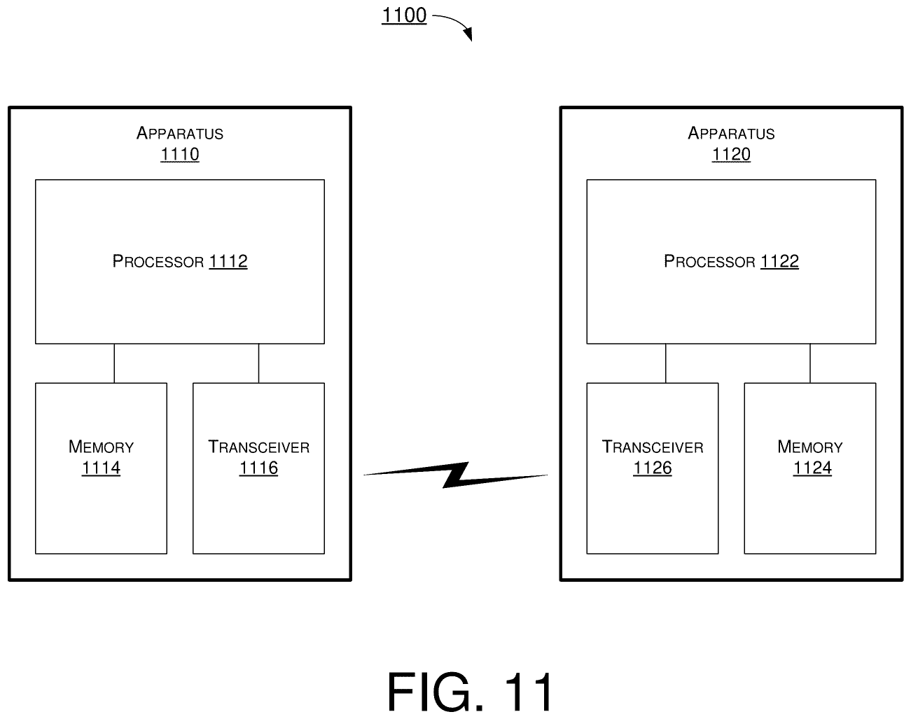

FIG. 11 illustrates an example system 1100 having at least an example apparatus 1110 and an example apparatus 1120 in accordance with an implementation of the present disclosure. Each of apparatus 1110 and apparatus 1120 may perform various functions to implement schemes, techniques, processes and methods described herein pertaining to DRU allocation and scheduling for mixed-distribution bandwidth operations in wireless communications, including the various schemes described above with respect to various proposed designs, concepts, schemes, systems and methods described above as well as processes described below. For instance, apparatus 1110 may be implemented in STA 110 and apparatus 1120 may be implemented in STA 120, or vice versa.

Each of apparatus 1110 and apparatus 1120 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1110 and apparatus 1120 may be implemented in a smartphone, a smart watch, a personal digital assistant, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a wire communication apparatus or a computing apparatus. For instance, each of apparatus 1110 and apparatus 1120 may be implemented in a smart thermostat, a smart fridge, a smart door lock, a wireless speaker or a home control center. When implemented in or as a network apparatus, apparatus 1110 and/or apparatus 1120 may be implemented in a network node, such as an AP in a WLAN.

In some implementations, each of apparatus 1110 and apparatus 1120 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1110 and apparatus 1120 may be implemented in or as a STA or an AP. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, one or more RISC processors or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to DRU allocation and scheduling for mixed-distribution bandwidth operations in wireless communications in accordance with various implementations of the present disclosure.

In some implementations, apparatus 1110 may also include a transceiver 1116 coupled to processor 1112. Transceiver 1116 may include a transmitter capable of wirelessly transmitting and a receiver capable of wirelessly receiving data. In some implementations, apparatus 1120 may also include a transceiver 1126 coupled to processor 1122. Transceiver 1126 may include a transmitter capable of wirelessly transmitting and a receiver capable of wirelessly receiving data. It is noteworthy that, although transceiver 1116 and transceiver 1126 are illustrated as being external to and separate from processor 1112 and processor 1122, respectively, in some implementations, transceiver 1116 may be an integral part of processor 1112 as a system on chip (SoC), and transceiver 1126 may be an integral part of processor 1122 as a SoC.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110, as STA 110, and apparatus 1120, as STA 120, is provided below in the context of example process 1200. It is noteworthy that, although a detailed description of capabilities, functionalities and/or technical features of either of apparatus 1110 and apparatus 1120 is provided below, the same may be applied to the other of apparatus 1110 and apparatus 1120 although a detailed description thereof is not provided solely in the interest of brevity. It is also noteworthy that, although the example implementations described below are provided in the context of WLAN, the same may be implemented in other types of networks.

### Illustrative Processes

FIG. 12 illustrates an example process 1200 in accordance with an implementation of the present disclosure. Process 1200 may represent an aspect of implementing various proposed designs, concepts, schemes, systems and methods described above. More specifically, process 1200 may represent an aspect of the proposed concepts and schemes pertaining to DRU allocation and scheduling for mixed-distribution bandwidth operations in wireless communications in accordance with the present disclosure. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks/sub-blocks of process 1200 may be executed in the order shown in FIG. 12 or, alternatively, in a different order. Furthermore, one or more of the blocks/sub-blocks of process 1200 may be executed repeatedly or iteratively. Process 1200 may be implemented by or in apparatus 1110 and apparatus 1120 as well as any variations thereof. Solely for illustrative purposes and without limiting the scope, process 1200 is described below in the context of apparatus 1110 implemented in or as STA 110 functioning as a non-AP STA and apparatus 1120 implemented in or as STA 120 functioning as an AP STA of a wireless network such as a WLAN in network environment 100 in accordance with one or more of IEEE 802.11 standards. Process 1200 may begin at block 1210.

At 1210, process 1200 may involve processor 1122 of apparatus 1120 allocating a plurality of DRU sizes on a plurality of distribution bandwidths to a plurality of STAs (e.g., including apparatus 1110 as STA 110). Process 1200 may proceed from 1210 to 1220.

At 1220, process 1200 may involve processor 1122 communicating, via transceiver 1126, with one or more of the plurality of STAs with a plurality of DRUs that are scheduled with one or more of the plurality of DRU sizes on one or more of the plurality of distribution bandwidths such that there is no overlap of tones of the plurality of DRUs.

In some implementations, in allocating the plurality of DRU sizes on the plurality of distribution bandwidths, process 1200 may involve processor 1122 allocating the plurality of DRU sizes on the plurality of distribution bandwidths such that there is a mutual exclusion in a frequency domain between a first DRU of the plurality of DRUs scheduled for a first STA of the plurality of STAs for transmission on a first distribution bandwidth and a second DRU of the plurality of DRUs scheduled for a second STA of the plurality of STAs for transmission on a second distribution bandwidth. Moreover, the plurality of DRUs may follow a hierarchical structure similar to that for regular, non-distributed resource units (RRUs).

In some implementations, according to design 300, the first DRU may include a DRU484 distributed on an 80 MHz bandwidth or a DRU996 distributed on a 160 MHz bandwidth. Correspondingly, the second DRU may include a DRU52 distributed on the 80 MHz bandwidth, a DRU106 distributed on the 80 MHz bandwidth, a DRU242 distributed on the 80 MHz or 160 MHz bandwidth, or another DRU484 distributed on the 160 MHz bandwidth.

In some implementations, according to design 300, the first DRU may include a DRU242 distributed on an 80 MHz bandwidth or a DRU484 distributed on a 160 MHz bandwidth. Correspondingly, the second DRU may include a DRU52 distributed on the 80 MHz bandwidth, a DRU106 distributed on the 80 MHz bandwidth, another DRU242 distributed on the 160 MHz bandwidth, another DRU484 distributed on the 80 MHz bandwidth, or a DRU996 distributed on the 160 MHz bandwidth.

In some implementations, according to design 300, the first DRU may include a DRU242 distributed on a 160 MHz bandwidth. Correspondingly, the second DRU may include a DRU52 distributed on an 80 MHz bandwidth, a DRU106 distributed on the 80 MHz bandwidth, another DRU242 distributed on the 80 MHz bandwidth, a DRU484 distributed on the 80 MHz or 160 MHz bandwidth, or a DRU996 distributed on the 160 MHz bandwidth.

In some implementations, according to design 400 and design 500, the first DRU may include a DRU484 distributed on an 80 MHz bandwidth, a DRU996 distributed on a 160 MHz bandwidth, or a DRU(2×996) distributed on a 320 MHz bandwidth. Correspondingly, the second DRU may include a DRU106 distributed on the 80 MHz or 160 MHz bandwidth, a DRU242 distributed on the 80 MHz or 160 MHz bandwidth, another DRU484 distributed on the 160 MHz or 320 MHz bandwidth, or another DRU996 distributed on the 320 MHz.

In some implementations, according to design 400 and design 500, the first DRU may include a DRU242 distributed on an 80 MHz bandwidth, a DRU484 distributed on a 160 MHz bandwidth, or a DRU996 distributed on a 320 MHz bandwidth. Correspondingly, the second DRU may include a DRU106 distributed on the 80 MHz or 160 MHz bandwidth, another DRU242 distributed on the 160 MHz bandwidth, another DRU484 distributed on the 80 MHz or 320 MHz bandwidth, another DRU996 distributed on the 160 MHz bandwidth, or a 2×996-tone DRU (DRU(2×996)) distributed on the 320 MHz bandwidth.

In some implementations, according to design 400 and design 500, the first DRU may include a DRU242 distributed on a 160 MHz bandwidth or a DRU484 distributed on a 320 MHz bandwidth. Correspondingly, the second DRU may include a DRU106 distributed on an 80 MHz bandwidth or the 160 MHz bandwidth, another DRU242 distributed on the 80 MHz bandwidth, another DRU484 distributed on the 160 MHz or 80 MHz bandwidth, a DRU996 distributed on the 160 MHz bandwidth, or a DRU(2×996) distributed on the 320 MHz bandwidth.

In some implementations, according to design 800, the first DRU may include a DRU242 distributed on an 80 MHz bandwidth or a DRU484 distributed on a 160 MHz bandwidth. Correspondingly, the second DRU may include another DRU242 distributed on a 240 MHz bandwidth, another DRU484 distributed on the 240 MHz bandwidth, or a RU996 distributed on the 240 MHz bandwidth.

In some implementations, according to design 1000, the first DRU may include a DRU242 or a DRU484 distributed on a 240 MHz bandwidth. Correspondingly, the second DRU may include another DRU484 distributed on a 320 MHz bandwidth, a DRU996 distributed on the 320 MHz bandwidth, or a DRU(2×996) distributed on the 320 MHz bandwidth.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
allocating, by a processor of an apparatus, a plurality of distributed-tone resource unit (DRU) sizes on a plurality of distribution bandwidths to a plurality of stations (STAs); and
communicating, by the processor, with one or more of the plurality of STAs with a plurality of DRUs that are scheduled with one or more of the plurality of DRU sizes on one or more of the plurality of distribution bandwidths such that there is no overlap of tones of the plurality of DRUs.

2. The method of claim 1, wherein the allocating of the plurality of DRU sizes on the plurality of distribution bandwidths comprises allocating the plurality of DRU sizes on the plurality of distribution bandwidths such that there is a mutual exclusion in a frequency domain between a first DRU of the plurality of DRUs scheduled for a first STA of the plurality of STAs for transmission on a first distribution bandwidth and a second DRU of the plurality of DRUs scheduled for a second STA of the plurality of STAs for transmission on a second distribution bandwidth, and wherein the plurality of DRUs follow a hierarchical structure similar to that for regular, non-distributed resource units (RRUs).

3. The method of claim 2, wherein:
the first DRU comprises a 484-tone DRU (DRU484) distributed on an 80 MHz bandwidth or a 996-tone DRU (DRU996) distributed on a 160 MHz bandwidth, and
the second DRU comprises a 52-tone DRU (DRU52) distributed on the 80 MHz bandwidth, a 106-tone DRU (DRU106) distributed on the 80 MHz bandwidth, a 242-tone DRU (DRU242) distributed on the 80 MHz or 160 MHz bandwidth, or another DRU484 distributed on the 160 MHz bandwidth.

4. The method of claim 2, wherein:
the first DRU comprises a 242-tone DRU (DRU242) distributed on an 80 MHz bandwidth or a 484-tone DRU (DRU484) distributed on a 160 MHz bandwidth, and
the second DRU comprises a 52-tone DRU (DRU52) distributed on the 80 MHz bandwidth, a 106-tone DRU (DRU106) distributed on the 80 MHz bandwidth, another DRU242 distributed on the 160 MHz bandwidth, another DRU484 distributed on the 80 MHz bandwidth, or a 996-tone DRU (DRU996) distributed on the 160 MHz bandwidth.

5. The method of claim 2, wherein:
the first DRU comprises a 242-tone DRU (DRU242) distributed on a 160 MHz bandwidth, and
the second DRU comprises a 52-tone DRU (DRU52) distributed on an 80 MHz bandwidth, a 106-tone DRU (DRU106) distributed on the 80 MHz bandwidth, another DRU242 distributed on the 80 MHz bandwidth, a 484-tone DRU (DRU484) distributed on the 80 MHz or 160 MHz bandwidth, or a 996-tone DRU (DRU996) distributed on the

6. The method of claim 2, wherein:
the first DRU comprises a 484-tone DRU (DRU484) distributed on an 80 MHz bandwidth, a 996-tone DRU (DRU996) distributed on a 160 MHz bandwidth, or a 2×996-tone DRU (DRU(2×996)) distributed on a 320 MHz bandwidth, and
the second DRU comprises a 106-tone DRU (DRU106) distributed on the 80 MHz or 160 MHz bandwidth, a 242-tone DRU (DRU242) distributed on the 80 MHz or 160 MHz bandwidth, another DRU484 distributed on the 160 MHz or 320 MHz bandwidth, or another DRU996 distributed on the 320 MHz.

7. The method of claim 2, wherein:
the first DRU comprises a 242-tone DRU (DRU242) distributed on an 80 MHz bandwidth, a 484-tone DRU (DRU484) distributed on a 160 MHz bandwidth, or a 996-tone DRU (DRU996) distributed on a 320 MHz bandwidth, and
the second DRU comprises a 106-tone DRU (DRU106) distributed on the 80 MHz or 160 MHz bandwidth, another DRU242 distributed on the 160 MHz bandwidth, another DRU484 distributed on the 80 MHz or 320 MHz bandwidth, another DRU996 distributed on the 160 MHz bandwidth, or a 2×996-tone DRU (DRU(2x996)) distributed on the 320 MHz bandwidth.

8. The method of claim 2, wherein:
the first DRU comprises a 242-tone DRU (DRU242) distributed on a 160 MHz bandwidth or a 484-tone DRU (DRU484) distributed on a 320 MHz bandwidth, and
the second DRU comprises a 106-tone DRU (DRU106) distributed on an 80 MHz bandwidth or the 160 MHz bandwidth, another DRU242 distributed on the 80 MHz bandwidth, another DRU484 distributed on the 160 MHz or 80 MHz bandwidth, a 996-tone DRU (DRU996) distributed on the 160 MHz bandwidth, or a 2×996-tone DRU (DRU(2×996)) distributed on the 320 MHz bandwidth.

9. The method of claim 2, wherein:
the first DRU comprises a 242-tone DRU (DRU242) distributed on an 80 MHz bandwidth or a 484-tone DRU (DRU484) distributed on a 160 MHz bandwidth, and
the second DRU comprises another DRU242 distributed on a 240 MHz bandwidth, another DRU484 distributed on the 240 MHz bandwidth, or a 996-tone DRU (DRU996) distributed on the 240 MHz bandwidth.

10. The method of claim 2, wherein:
the first DRU comprises a 242-tone DRU (DRU242) or a 484-tone DRU (DRU484) distributed on a 240 MHz bandwidth, and
the second DRU comprises another DRU484 distributed on a 320 MHz bandwidth, a 996-tone DRU (DRU996) distributed on the 320 MHz bandwidth, or a 2×996-tone DRU (DRU(2×996)) distributed on the 320 MHz bandwidth.

11. An apparatus, comprising:
a transceiver configured to communicate wirelessly; and
a processor coupled to the transceiver and configured to perform operations comprising:
allocating a plurality of distributed-tone resource unit (DRU) sizes on a plurality of distribution bandwidths to a plurality of stations (STAs); and
communicating, via the transceiver, with one or more of the plurality of STAs with a plurality of DRUs that are scheduled with one or more of the plurality of DRU sizes on one or more of the plurality of distribution bandwidths such that there is no overlap of tones of the plurality of DRUs.

12. The apparatus of claim 11, wherein the allocating of the plurality of DRU sizes on the plurality of distribution bandwidths comprises allocating the plurality of DRU sizes on the plurality of distribution bandwidths such that there is a mutual exclusion in a frequency domain between a first DRU of the plurality of DRUs scheduled for a first STA of the plurality of STAs for transmission on a first distribution bandwidth and a second DRU of the plurality of DRUs scheduled for a second STA of the plurality of STAs for transmission on a second distribution bandwidth, and wherein the plurality of DRUs follow a hierarchical structure similar to that for regular, non-distributed resource units (RRUs).

13. The apparatus of claim 12, wherein:
the first DRU comprises a 484-tone DRU (DRU484) distributed on an 80 MHz bandwidth or a 996-tone DRU (DRU996) distributed on a 160 MHz bandwidth, and
the second DRU comprises a 52-tone DRU (DRU52) distributed on the 80 MHz bandwidth, a 106-tone DRU (DRU106) distributed on the 80 MHz bandwidth, a 242-tone DRU (DRU242) distributed on the 80 MHz or 160 MHz bandwidth, or another DRU484 distributed on the 160 MHz bandwidth.

14. The apparatus of claim 12, wherein:
the first DRU comprises a 242-tone DRU (DRU242) distributed on an 80 MHz bandwidth or a 484-tone DRU (DRU484) distributed on a 160 MHz bandwidth, and
the second DRU comprises a 52-tone DRU (DRU52) distributed on the 80 MHz bandwidth, a 106-tone DRU (DRU106) distributed on the 80 MHz bandwidth, another DRU242 distributed on the 160 MHz bandwidth, another DRU484 distributed on the 80 MHz bandwidth, or a 996-tone DRU (DRU996) distributed on the 160 MHz bandwidth.

15. The apparatus of claim 12, wherein:
the first DRU comprises a 242-tone DRU (DRU242) distributed on a 160 MHz bandwidth, and
the second DRU comprises a 52-tone DRU (DRU52) distributed on an 80 MHz bandwidth, a 106-tone DRU (DRU106) distributed on the 80 MHz bandwidth, another DRU242 distributed on the 80 MHz bandwidth, a 484-tone DRU (DRU484) distributed on the 80 MHz or 160 MHz bandwidth, or a 996-tone DRU (DRU996) distributed on the

16. The apparatus of claim 12, wherein:
the first DRU comprises a 484-tone DRU (DRU484) distributed on an 80 MHz bandwidth, a 996-tone DRU (DRU996) distributed on a 160 MHz bandwidth, or a 2×996-tone DRU (DRU(2×996)) distributed on a 320 MHz bandwidth, and
the second DRU comprises a 106-tone DRU (DRU106) distributed on the 80 MHz or 160 MHz bandwidth, a 242-tone DRU (DRU242) distributed on the 80 MHz or 160 MHz bandwidth, another DRU484 distributed on the 160 MHz or 320 MHz bandwidth, or another DRU996 distributed on the 320 MHz.

17. The apparatus of claim 12, wherein:
the first DRU comprises a 242-tone DRU (DRU242) distributed on an 80 MHz bandwidth, a 484-tone DRU (DRU484) distributed on a 160 MHz bandwidth, or a 996-tone DRU (DRU996) distributed on a 320 MHz bandwidth, and
the second DRU comprises a 106-tone DRU (DRU106) distributed on the 80 MHz or 160 MHz bandwidth, another DRU242 distributed on the 160 MHz bandwidth, another DRU484 distributed on the 80 MHz or 320 MHz bandwidth, another DRU996 distributed on the 160 MHz bandwidth, or a 2×996-tone DRU (DRU (2×996)) distributed on the 320 MHz bandwidth.

18. The apparatus of claim 12, wherein:
the first DRU comprises a 242-tone DRU (DRU242) distributed on a 160 MHz bandwidth or a 484-tone DRU (DRU484) distributed on a 320 MHz bandwidth, and
the second DRU comprises a 106-tone DRU (DRU106) distributed on an 80 MHz bandwidth or the 160 MHz bandwidth, another DRU242 distributed on the 80 MHz bandwidth, another DRU484 distributed on the 160 MHz or 80 MHz bandwidth, a 996-tone DRU (DRU996) distributed on the 160 MHz bandwidth, or a 2×996-tone DRU (DRU(2×996)) distributed on the 320 MHz bandwidth.

19. The apparatus of claim 12, wherein:
the first DRU comprises a 242-tone DRU (DRU242) distributed on an 80 MHz bandwidth or a 484-tone DRU (DRU484) distributed on a 160 MHz bandwidth, and
the second DRU comprises another DRU242 distributed on a 240 MHz bandwidth, another DRU484 distributed on the 240 MHz bandwidth, or a 996-tone DRU (DRU996) distributed on the 240 MHz bandwidth.

20. The apparatus of claim 12, wherein:
the first DRU comprises a 242-tone DRU (DRU242) or a 484-tone DRU (DRU484) distributed on a 240 MHz bandwidth, and
the second DRU comprises another DRU484 distributed on a 320 MHz bandwidth, a 996-tone DRU (DRU996) distributed on the 320 MHz bandwidth, or a 2×996-tone DRU (DRU(2×996)) distributed on the 320 MHz bandwidth.
